(19) United States
(12) Patent Application Publication
(10) Pub. No.: US 2024/0195820 A1
(43) Pub. Date: Jun. 13, 2024

(54) CONTINUOUS API-BASED FRAUD DETECTION USING SEQUENCES

(71) Applicant: Traceable Inc., San Francisco, CA (US)

(72) Inventors: Jisheng Wang, San Francisco, CA (US); Sudeep Padiyar, Cupertino, CA (US)

(73) Assignee: Traceable Inc., San Francisco, CA (US)

(21) Appl. No.: 18/227,515

(22) Filed: Jul. 28, 2023

Related U.S. Application Data
(60) Provisional application No. 63/431,011, filed on Dec. 7, 2022.

(51) Int. Cl. H04L 9/40; G06F 9/54

(52) U.S. Cl. CPC H04L 63/1416; G06F 9/547; H04L 63/1425; H04L 2463/102

(57) ABSTRACT

A state-based continuous detection and monitoring systems detects a fraud ring over time. The present system may perform modular detection (at the state level) and hierarchical detection (at the sequence level) covering different approaches of fraudulent activities, both separately and jointly. Once a fraudulent event is detected in a state or sequence, a severity score is determined using a machine learning. A complete fraud investigation platform is implemented which uses out-of-the-box detection mechanisms while allowing users to define their own event detection as well. The state-based detection and continuous monitoring with visibility into the details of API activity allow the present system to detect fraudulent rings perpetrated by one or more users.

### CROSS REFERENCE TO RELATED APPLICATIONS

The present application claims the priority benefit of U.S. provisional patent application 63/431,011, filed on Dec. 7, 2022, titled “API-Based Fraud Detection,” the disclosure of which is incorporated herein by reference.

### BACKGROUND

Web-based applications have been subject to entity attacks that seek to improperly access data. Early attacks were based on viruses that could be identified as a specification file. Many modern attacks, however, are targeted towards application program interfaces (APIs), and cannot be detected by specification violations. Most security solutions look for known patterns of exploitations of specialized portions of a service, such as an invalid credit card number or stolen credit card. These are similar to antivirus market solutions based on file signatures. What is needed is an improved system for detecting fraud in API systems.

### SUMMARY

the present technology provides state-based continuous detection and monitoring of a fraud ring over time. A fraud ring may involve one or more users creating multiple accounts with a network-based service to engage in fraudulent activity on that service. The present system may perform modular detection (at the state level) and hierarchical detection (at the sequence level) covering different approaches of fraudulent activities, both separately and jointly. The states, for example may be the steps or APIs typically accessed by a user of the service. Once a fraudulent event is detected in a state or sequence, a severity score is determined using a machine learning. The machine learning mechanism may determine severity based on scope, duration, state, existing damage, and predicted damage. A complete fraud investigation platform is implemented which uses out-of-the-box detection mechanisms while allowing users to define their own event detection as well. The state-based detection and continuous monitoring with visibility into the details of API activity allow the present system to detect fraudulent rings perpetrated by one or more users.

In some instances, a method performs continuous API-based fraud detection based on sequences. The method begins with continuously intercepting API traffic between a client and a server, wherein the API traffic associated with multiple sequences of stages. The method continues with identifying a first sequence associated with a plurality of stages, wherein the stages and sequence determined from the intercepted API traffic. Next, the system detects whether the sequence of stages is associated with a fraudulent event. An alert is then reported based on the detection of the fraudulent event.

In some instances, a non-transitory computer readable storage medium has embodied thereon a program that is executable by a processor to perform continuous API-based fraud detection based on sequences. The method begins with continuously intercepting API traffic between a client and a server, wherein the API traffic associated with multiple sequences of stages. The method continues with identifying a first sequence associated with a plurality of stages, wherein the stages and sequence determined from the intercepted API traffic. Next, the system detects whether the sequence of stages is associated with a fraudulent event. An alert is then reported based on the detection of the fraudulent event.

In embodiments, a system can include a server, memory and one or more processors. One or more modules may be stored in memory and executed by the processors to continuously intercept API traffic between a client and a server, the API traffic associated with multiple sequences of stages, identify a first sequence associated with a plurality of stages, the stages and sequence determined from the intercepted API traffic, detect whether the sequence of stages is associated with a fraudulent event, and report an alert based on the detection of the fraudulent event.

### BRIEF DESCRIPTION OF FIGURES

FIG. 1 is a block diagram for performing API-based fraud detection using machine learning.

FIG. 2 is a block diagram of an application for performing fraud detection.

FIG. 3 is a block diagram of a prediction engine.

FIG. 4 illustrates sequences made up of states.

FIG. 5 is a method for performing API-based fraud detection using machine learning.

FIG. 6 is a method for determining an API sequence data.

FIG. 7 is a method for detecting fraud by user on a service based on state in sequence API data.

FIG. 8 is a method for detecting a fraud event for an individual state.

FIG. 9 is a method for applying APA data and user data to detect fraud.

FIG. 10 is a method for applying API data and user data to detect fraud.

FIG. 11 illustrates an interface of potentially fraudulent users.

FIG. 12 illustrates a computing environment for use with the present technology.

### DETAILED DESCRIPTION

The present technology provides state-based continuous detection and monitoring of a fraud ring over time. A fraud ring may involve one or more users creating multiple accounts with a network-based service to engage in fraudulent activity on that service. The present system may perform modular detection (at the state level) and hierarchical detection (at the sequence level) covering different approaches of fraudulent activities, both separately and jointly. The states, for example may be the steps or APIs typically accessed by a user of the service. Once a fraudulent event is detected in a state or sequence, a severity score is determined using a machine learning. The machine learning mechanism may determine severity based on scope, duration, state, existing damage, and predicted damage. A complete fraud investigation platform is implemented which uses out-of-the-box detection mechanisms while allowing users to define their own event detection as well. The state-based detection and continuous monitoring with visibility into the details of API activity allow the present system to detect fraudulent rings perpetrated by one or more users.

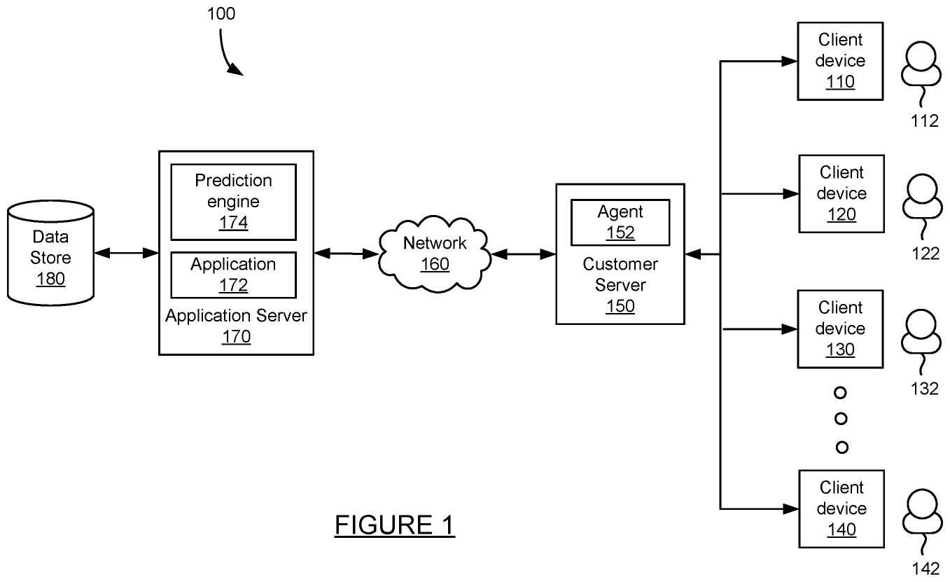

FIG. 1 is a block diagram for performing API-based fraud detection using machine learning. System 100 of FIG. 1 includes data store 180, application server 170, customer server 150, client devices 110, 120, 130, and 140, and users 112, 122, 132, and 142. Customer server includes agent 152. Application server includes application 172 and prediction engine 174.

Client devices 110-140 may send API requests to and receive API responses from customer server 150. The client devices may be any device which can access the service, network page, webpage, or other content provided by customer server 150. Client devices 110-140 may send a request to customer server 150, for example to an API provided by customer server 150, and customer server 150 may send a response to the devices based on the request. The request may be sent to a particular URL provided by customer server 150 and the response may be sent from the server to the device in response to the request. Though only four client devices are shown, a typical system may handle requests from a larger number of clients, for example, dozens, hundreds, or thousands, and any number of client devices may be used to interact with customer server 150.

Customer server 150 may provide a service to client devices 110-140. The service may be accessible through APIs provided by customer server 150. Agent 152 on customer server 150 may monitor the communication between customer server 150 and client devices 110-140 and intercept traffic transmitted between the server and the devices. Upon intercepting the traffic, agent 152 may forward the traffic to application 172 on application server 170. In some instances, one or more agents may be installed on customer server 150, which may be implemented by one or more physical or logical machines. In some instances, server 150 may actually be implemented by multiple servers in different locations, providing a distributed service for devices 110-140. In any case, one or more agents 152 may be installed to intercept API requests and responses between devices 110-140 and customer server 150, in some instances may aggregate the traffic by API request and response data, and may transmit request and response data to application 172 on server 170.

Network 140 may include one or more private networks, public networks, intranets, the Internet, an intranet, wide-area networks, local area networks, cellular networks, radio-frequency networks, Wi-Fi networks, any other network which may be used to transmit data, and any combination of these networks. Client devices 110-140, customer server 150, Application server 170, and data store 180 may all communicate over network 160 (whether or not labeled so in FIG. 1).

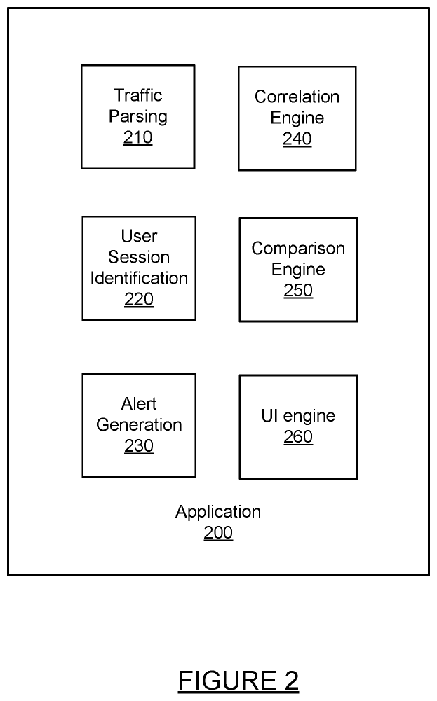

Application server 170 may be implemented as one or more physical or logical machines that provide functionality as described herein. In some instances, application server 170 may include one or more applications 172 and prediction engine 174. The application 172 may be stored on one or more application servers 170 and be executed to perform functionality as described herein. Application server and application 172 may both communicate over network 160 with data store 180. Application 172 is discussed in more detail with respect to FIG. 2.

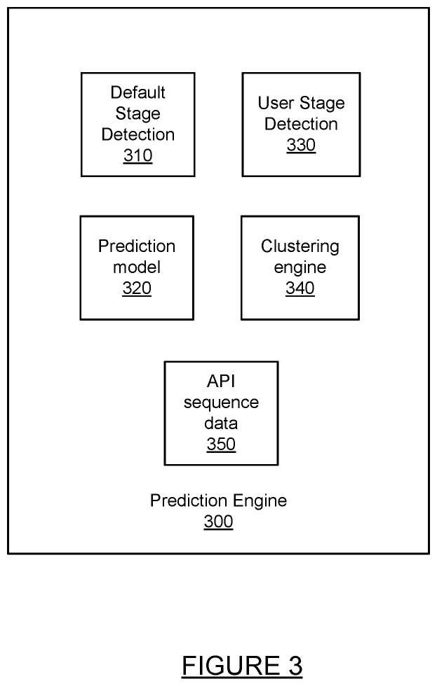

Prediction engine 174 may include one or more prediction engines used to predict fraudulent activity, a severity score, and perform other functionality discussed herein. Prediction engine 174 may be implemented by one or more algorithms, one or more machine learning models, and other components. Production engine 174 is discussed in more detail with respect to the block diagram of FIG. 3.

Data store 180 may be accessible at least by application server 170, application 172, and prediction engine 174. In some instance, data store 180 may include one or more APIs, API descriptions, metric data, and other data referenced and/or described herein. In some instance, data store 180 may be implemented as one or more data stores at one or more locations.

FIG. 2 is a block diagram of an application for performing fraud detection. Application 200 of FIG. 2 includes traffic parsing 210, user session identification 220, alert generation 230, correlation engine 240, comparison engine 250, and UI engine 260.

Traffic parsing module 210 may parse intercepted traffic to identify a user identity and user session, API request data, API response data, and other data contained within traffic between a server and a client. In some instances, traffic parsing module 210 may retrieve data used to correlate a request and a response, data used to identify sequences of APIs, data used to identify user roles for a particular user session, and other data.

User session identification module 220 may identify a user session based on data retrieved from APIs, a client, or other data. User session identification 220 may implement multiple methods to determine a user session, for example from objects in an API request or response header, other header content, in a response received from an application, or other source of information. Correlation engine 230 may identify correlations between APIs, identify API sequences, identify user roles within a user session, and create correlation data based on detected correlations.

Comparison engine 240 may compare APIs within a particular user session to correlation data detected from previous user sessions. The comparisons may include comparing API sequences, API parameters that are common to multiple API components (for example, an API request and an API response), user roles, and other correlation elements. Alert generation module 250 may generate an alert based on the results provided by comparison engine 240.

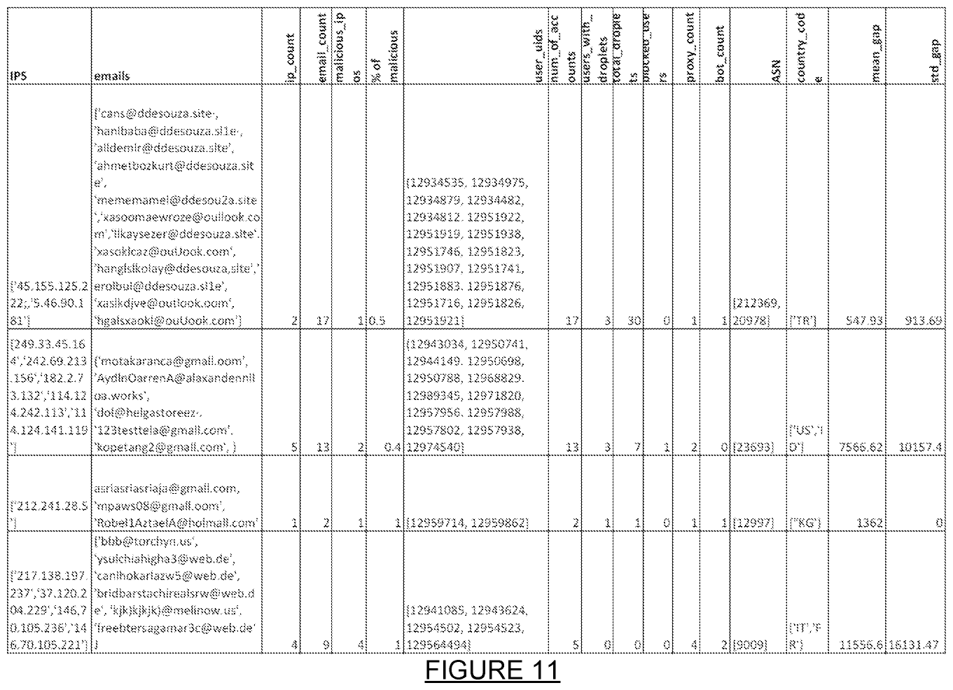

User interface engine 260 may collect user session data, correlation data, comparison data, and other API data and display raw or processed data to a user through a dashboard or other user interface. In some instances, a user may provide input selecting a fraudulent event, and user interface engine 260 may provide data, for example in the form of a table, through the interface regarding the fraudulent event. An example of data provided in response to selection of a fraudulent event is illustrated in FIG. 11.

In some instances, the present system may report fraudulent event data and/or alert data through a dashboard. UI engine 260 may generate and provide a dashboard to a user, for example as a webpage over network. The dashboard manager may coordinate graphics, perform analysis of fraudulent data, and provide an interface that can be interacted with by a user.

In some instances, more or fewer modules may be implemented in one or more applications to perform the functionality herein. The discussion of the modules with an application 200 is not intended to be limiting. The modules displayed can be combined, distributed, additional, or fewer modules then described, which will collectively perform the functionality described herein.

FIG. 3 is a block diagram of a prediction engine. Prediction engine 300 of FIG. 3 includes default state detection 310, prediction module 320, user state detection 330, clustering engine 340, and API sequence data 350. Default state detection 310 includes detection mechanisms that may process API activity associated with a particular state in a sequence to determine if there is a fraudulent event associated with that particular state. The state detection mechanism may include algorithms, models, and/or mechanisms.

A prediction model 320 may include one or more models, algorithms, or processes that receive an input, apply processing to the input, and output a prediction. In some instances, prediction model 320 may be implemented by one or more machine learning models. User state detection 330 may include data, algorithms, or other mechanisms for detecting fraud at a particular state based on data provided by a user. User state detection differs from default state detection in that the default state prediction is pre-generated to apply to all systems, while user state detection is custom generated for a particular system.

Clustering engine 340 may operate to perform clustering on certain data, such as user data, user IPs, or other data collected while monitoring API communication. API sequence data may include a sequence of one or more states that form a connected sequence. For example, for a sequence related to a bank transfer, the states or states in the sequence may include a user login, the user selection of an account, displaying account data to the user, receiving user input to select a transfer, receiving user input regarding the transfer, providing the transfer data to the user to be confirmed, receiving user confirmation, and then proceeding with the transfer. Each step may be a state in the overall sequence.

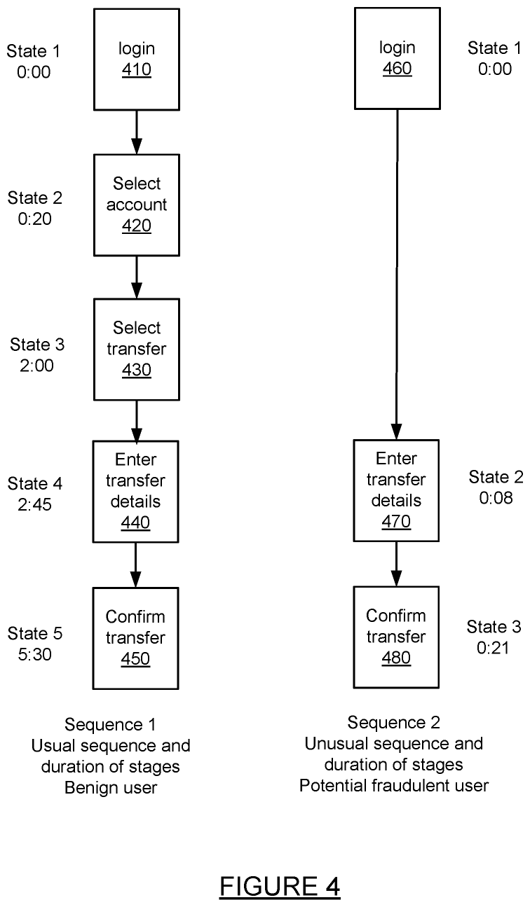

FIG. 4 illustrates exemplary sequences consisting of multiple states. Sequence 1 in FIG. 4 is a typical sequence for a benign user performing a balance transfer through a banking website. The benign user of sequence 1 is not involved in a fraudulent event. Sequence 1 includes five states, and takes five minutes and 30 seconds to complete the sequence. The states are login 410, selecting an account 420, selecting a transfer 430, entering transfer details at 440, and confirming the transfer at 450. This is the typical sequence for a bank transfer, and indicates the typical duration of each state. For example, the first state begins at 0:00, the second state ends at 0:20 seconds, the third state ends at 2:00 minutes, the fourth state ends at 2:45 minutes, and the duration for the entire sequence is 5:30.

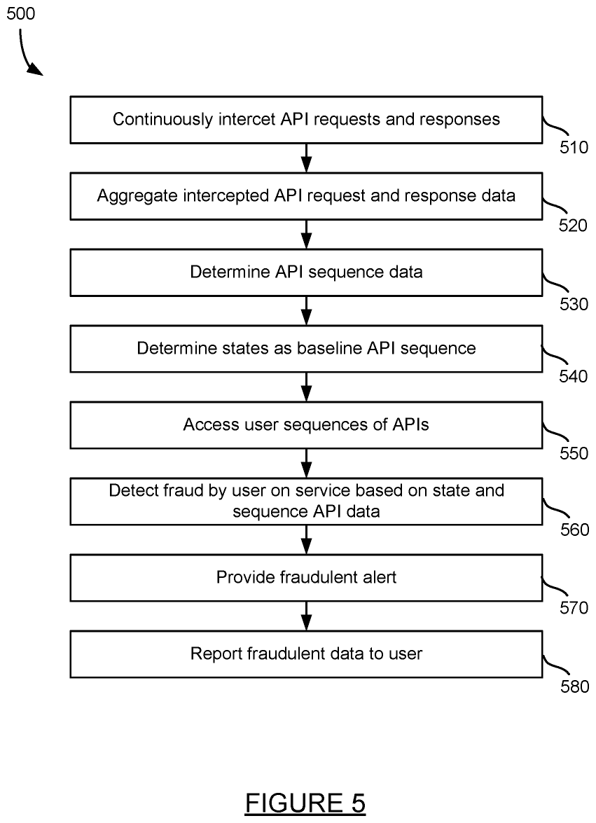

Sequence 2 is a suspicious sequence for the same type of operation, performing a transfer of funds for a bank account. In sequence 2, state 1 is login 460, state 2 is entering transfer details at step 470, and step three is confirming the transfer at step 480. Note that the typical time between login and entering transfer details, as shown in sequence 1, is 2:45. In sequence two, the time between login and entering transfer details is eight seconds (0:08). This indicates an urgency of a potentially fraudulent user to make a transfer without being detected. Similarly, typical users enter the transfer details carefully, as shown by a nearly 2 minute differential between state four and state 5 in sequence one. In sequence two, the time to enter transfer details, between state 1 and state 2, is 13 seconds. Sequence two suggests a potentially fraudulent event based on the differential in the states of the sequence as well as the difference in duration of the overall sequence. Hence, though no particular state in sequence two triggers a fraudulent event, the overall sequence, including the skipped states and overall duration between states, will likely trigger a fraudulent event. Detecting a fraudulent event at both the state and the sequence level is discussed with respect to FIGS. 5-11.

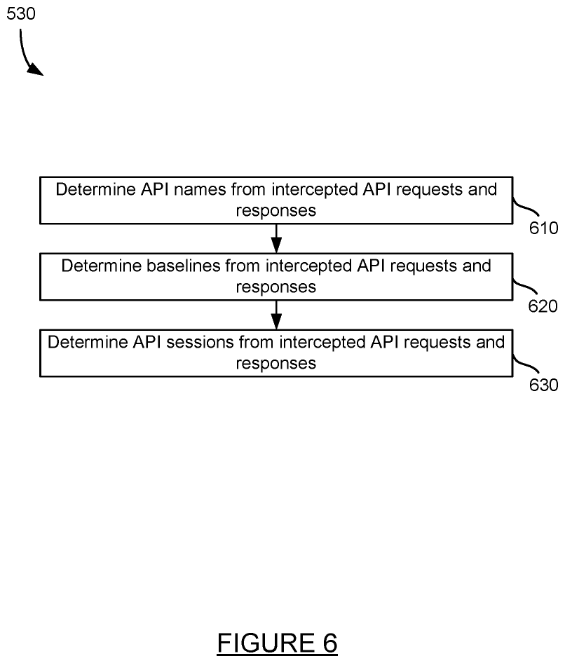

FIG. 5 is a method for performing API-based fraud detection using machine learning. The method 500 of FIG. 5 begins with continuously intercepting API requests and responses at step 510. The intercepted API request and response data is then aggregated at step 520. The aggregation can be performed by one or more agents on the customer server or by application 172 on server 170. API sequence data may be determined at step 530. determining API sequence data may include identifying API names, determining API baselines, and identifying API sessions. More details for determining API sequence data is discussed with respect to the method of FIG. 6.

A baseline API sequence with states is determined at step 540. Determining the baseline API sequence may include identifying which states are normally in the API sequence based on historical data, or by user input. For example, an API service may be monitored for a period of time, such as one hour, two hours, 10 hours, or some other period of time. The most common sequence of states may be set as the baseline sequence of states.

Once a baseline is determined, a user sequence of APIs is accessed at step 550. The user sequence includes the states or individual APIs accessed by the user while performing a business operation provided by a network service, for example to transfer funds, purchase a product, or other operation.

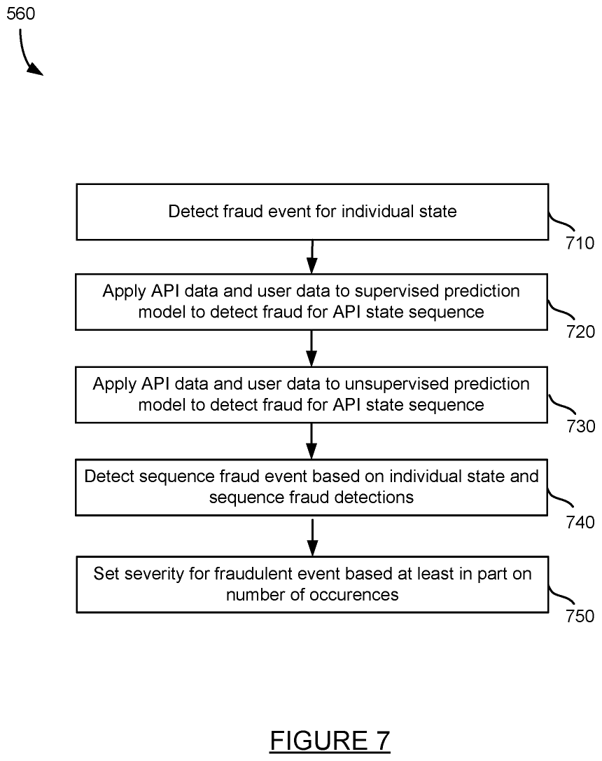

Fraud is detected by a user at the network service based on state and sequence API data at step 560. Determining fraud may include performing a supervised prediction process, an unsupervised prediction process, and identifying the severity score for a fraudulent event. A determination that a fraudulent event has occurred may be based on a combination of processing individual state API data, sequence data, and severity data. More detail for detecting fraud by a user on a network service based on state and sequence API data is discussed in more detail with respect to the method of FIG. 7.

A fraudulent alert may be generated and reported at step 570. If indeed a fraudulent event is detected, the system may send an alert to a user, administrator, or some other recipient. Fraudulent data may then be reported to a user at step 580. In addition to reporting on alert, additional details regarding the fraudulent event may be reported through a user interface. The additional data may include more details associated with the fraudulent event, such as for example, the APIs, user accounts, states, sequences, emails, and other data. An example of information provided three in interface is discussed with respect to the interface of FIG. 11.

FIG. 6 is a method for determining an API sequence data. The method of FIG. 6 provides more detail for step 530 the method of FIG. 5. API names are determined from the intercepted API requests and responses at step 610. The APIs are determined based on intercepted request and response API URLs, header information, URL nodes separated by forward slashes, and other data. More details for generating API names are disclosed in U.S. patent application Ser. No. 17/339,946, titled “Intelligent naming of Application Program Interfaces, filed on Jun. 5, 2021, the details of which are incorporated herein by reference.

Baselines from intercepted API requests and responses are determined at step 620. The baselines can be determined by tracking API request and response performance over time for the APIs of interest. More details for determining baselines are disclosed in U.S. patent application Ser. No. 17/339,951, titled Automatic Anomaly Detection based on API Sessions, filed on Jun. 5, 2021, the details of which are incorporated herein by reference.

API sessions are determined from intercepted API requests and responses at step 630. The API sessions are based on request and response data, as well as identified user sessions. More details for determining API sessions are disclosed in U.S. patent application Ser. No. 17/339,951, titled Automatic Anomaly Detection based on API Sessions, filed on Jun. 5, 2021, the details of which are incorporated herein by reference.

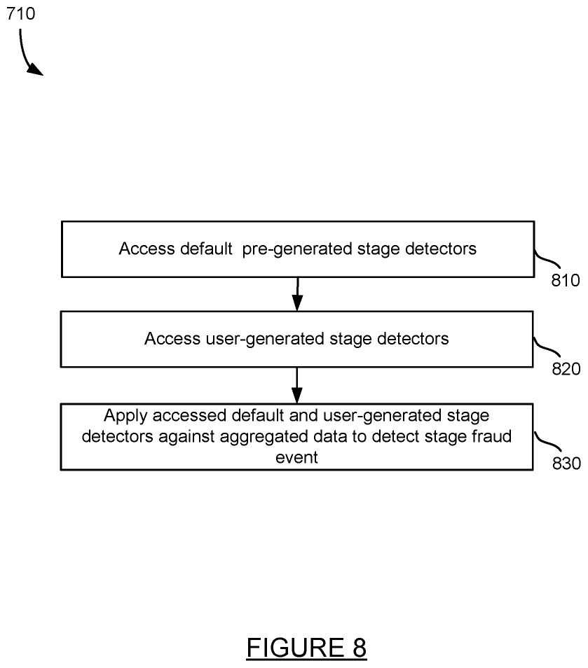

FIG. 7 is a method for detecting a fraudulent event associated with a user on a service based on state and sequence API data. The method of FIG. 7 provides more detail for step 560 of the method of FIG. 5. First, a fraud event is detected for an individual state at step 710. Detecting fraud for an individual state may involve applying a pre-generated or default state detectors and/or user generated state detectors to aggregated data to detect the fraudulent event. More detail for detecting a fraudulent event is discussed with respect to the method of FIG. 8.

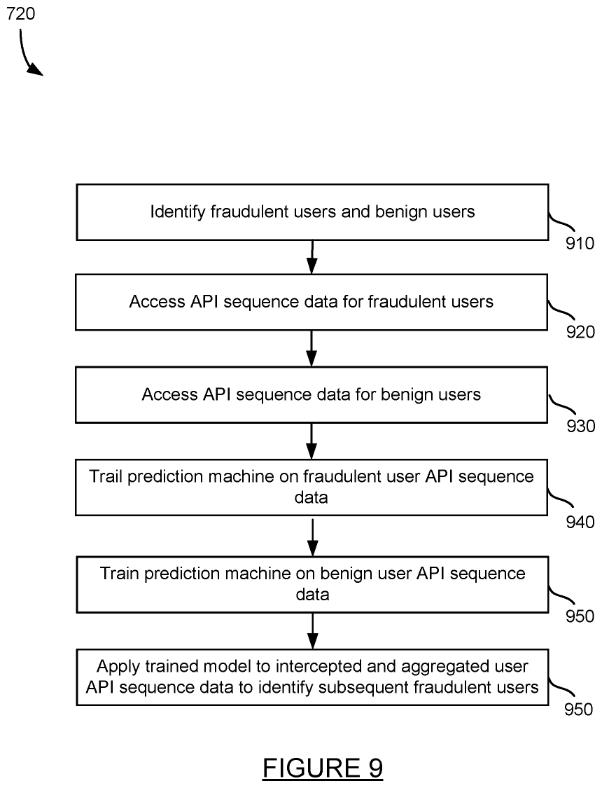

API data and user data may be applied to a supervised prediction model to detect a fraudulent event for an API state sequence at step 720. Applying API data to a supervised prediction model may include accessing API data for fraudulent users and benign users, training a machine based on the accessed API data, and then applying the trained model to subsequent real-life API data. More details for applying API data to a supervised prediction model is discussed with respect to the method of FIG. 9.

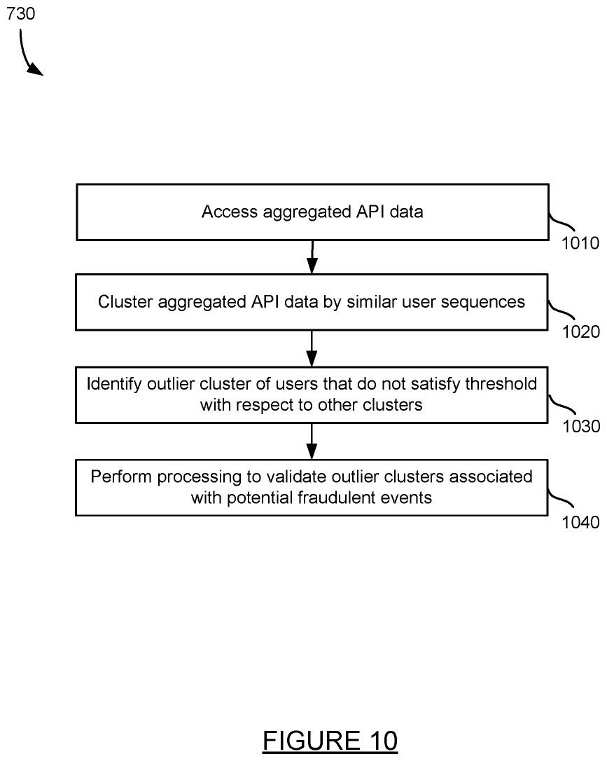

API data and user data may be applied to an unsupervised prediction model to detect fraud for an API state sequence at step 730. Applying data to an unsupervised prediction model may include clustering aggregated API data to form clusters of similar sequences for APIs, and identifying outlier clusters as potential fraudulent events. More details for applying data to an unsupervised prediction model is discussed with respect to the method of FIG. 10.

A severity for a fraudulent event is determined at step 750. In some instances, the severity may be set on at least part of the number of occurrences of the detected fraudulent event at step 750. In some instances, severity may be set merely as the number of times in which the fraudulent event is detected. In some instances, a severity may be predicted as an output of a machine learning model, wherein the model input includes API data associated with a sequence.

FIG. 8 is a method for detecting a fraud event for an individual state. The method of FIG. 8 provides more detail for step 710 the method of FIG. 7. First, default pre-generated state detectors are accessed at step 810. The pre-generated state detectors may be able to detect fraudulent attempts to generate a particular state or service provided by a network service. For example, a pre-generated state detector may be an algorithm or other software component to detect a fraudulent login, fraudulent money transfer request, fraudulent credit card entry, and other fraudulent requests associated with a particular network service stage. User generated state detectors may be accessed at step 820. User generated state detectors may be implemented as code, parameters, or data that can be processed to identify fraudulent events, fraudulent users, or other suspicious activity as defined by a user rather than a system provider.

The accessed default and user generated state detectors are applied against aggregated data to detect state fraudulent events at step 830. The aggregated data may include user data or IP addresses having similar behavior. Hence, if one of the pre-generated state detectors or user generated state detectors detects a potential fraudulent event, every user or user ID associated in that aggregated set of data may be deemed suspicious as a fraudulent user.

FIG. 9 is a method for applying API data and user data to detect fraud. The method of FIG. 9 provides more detail for step 720 of the method of FIG. 7. Fraudulent users and benign users are identified at step 910. A fraudulent user is one who is confirmed to have orchestrated a fraudulent event against a network service. A benign user is one who is confirmed to have not caused a fraudulent event against a network service.

API sequence data for the fraudulent users may be accessed at step 920. The API sequence data for the benign users may be accessed at step 930. A prediction machine may be trained based on the fraudulent user API sequence data at step 940. Training the prediction engine, such as a supervised machine learning engine, may be performed for several sets of fraudulent user API sequence data. The prediction machine may be trained on benign user API sequence data at step 950. The prediction engine, i.e., supervised machine learning engine, may be trained using several sets of fraudulent user API sequence data. Once the prediction machine is trained, the trained model can be applied to intercepted and aggregated user API sequence data to identify subsequent fraudulent users at step 950.

FIG. 10 is a method for applying API data and user data to detect fraud. The method of FIG. 10 provides more detail for step 730 of the method of FIG. 7. Aggregated API data is accessed at step 1010. The data may be aggregated based on API, user sequences, and/or other parameters. Aggregated API data is then clustered by similar user sequences at step 1020. Hence, sequences of APIs accessed by different users may be clustered together. Outlier clusters of users are identified that do not satisfy a threshold which respect to the other clusters at step 1030. At step 1030, outlier clusters are identified, for example, as those not within a distance of 50% with respect to other clusters. Processing may then be performed to validate outlier clusters associate with potential fraudulent events at step 1040. In some instances, the processing may be performed to determine if the clusters are truly associated with fraudulent events or not.

FIG. 11 illustrates an interface of potentially fraudulent users. The interface of FIG. 11 is a table that includes columns of the IPs, emails, IP count, email account, malicious IP's, percentage of malicious IP's, user IDs, number of accounts, users with droplets, total droplets, blocked users, proxy counts, bot counts, ASN, country codes, mean gap, and standard gap. In each row, a group of IPs that form a “ring” is displayed, with their corresponding emails, IP count, and other parameters. As shown in FIG. 11, the first column has two IPs, but 17 emails. As such, it is clear that a couple of users are creating multiple accounts for a particular service. This is highly suspicious activity, and may be used to determine that the ring made up of the two IP's is fraudulent.

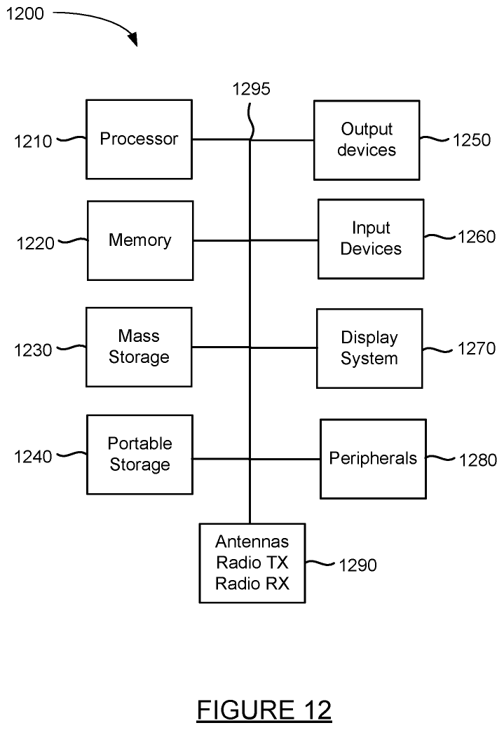

FIG. 12 is a block diagram of a system for implementing machines that implement the present technology. System 1200 of FIG. 12 may be implemented in the contexts of the likes of machines that implement client devices 110-140, customer server 150, Application server 120, and data store 180. The computing system 1200 of FIG. 12 includes one or more processors 1210 and memory 1220. Main memory 1220 stores, in part, instructions and data for execution by processor 1210. Main memory 1220 can store the executable code when in operation. The system 1200 of FIG. 12 further includes a mass storage device 1230, portable storage medium drive(s) 1240, output devices 1250, user input devices 1260, a graphics display 1270, and peripheral devices 1280.

The components shown in FIG. 12 are depicted as being connected via a single bus 1290. However, the components may be connected through one or more data transport means. For example, processor unit 1210 and main memory 1220 may be connected via a local microprocessor bus, and the mass storage device 1230, peripheral device(s) 1280, portable storage device 1240, and display system 1270 may be connected via one or more input/output (I/O) buses.

Mass storage device 1230, which may be implemented with a magnetic disk drive, an optical disk drive, a flash drive, or other device, is a non-volatile storage device for storing data and instructions for use by processor unit 1210. Mass storage device 1230 can store the system software for implementing embodiments of the present invention for purposes of loading that software into main memory 1220.

Portable storage device 1240 operates in conjunction with a portable non-volatile storage medium, such as a floppy disk, compact disk or Digital video disc, USB drive, memory card or stick, or other portable or removable memory, to input and output data and code to and from the computer system 1200 of FIG. 12. The system software for implementing embodiments of the present invention may be stored on such a portable medium and input to the computer system 1200 via the portable storage device 1240.

Input devices 1260 provide a portion of a user interface. Input devices 1260 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1200 as shown in FIG. 12 includes output devices 1250. Examples of suitable output devices include speakers, printers, network interfaces, and monitors.

Display system 1270 may include a liquid crystal display (LCD) or other suitable display device. Display system 1270 receives textual and graphical information and processes the information for output to the display device. Display system 1270 may also receive input as a touch-screen.

Peripherals 1280 may include any type of computer support device to add additional functionality to the computer system. For example, peripheral device(s) 1280 may include a modem or a router, printer, and other device.

The system of 1200 may also include, in some implementations, antennas, radio transmitters and radio receivers 1290. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1200 of FIG. 12 are those typically found in computer systems that may be suitable for use with embodiments of the present invention and are intended to represent a broad category of such computer components that are well known in the art. Thus, the computer system 1200 of FIG. 12 can be a personal computer, handheld computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for performing continuous API-based fraud detection based on sequences, comprising:
continuously intercepting API traffic between a client and a server, the API traffic associated with multiple sequences of stages;
identifying a first sequence associated with a plurality of stages, the stages and sequence determined from the intercepted API traffic;
detecting whether the sequence of stages is associated with a fraudulent event; and
reporting an alert based on the detection of the fraudulent event.

2. The method of claim 1, wherein each of the stages is associated with an API request and response.

3. The method of claim 1, wherein detecting a fraudulent event includes applying API data to a prediction model, the API data generated based on the intercepted API traffic.

4. The method of claim 1, wherein detecting a fraudulent event includes identifying a fraudulent event associated with a selected stage within the first sequence.

5. The method of claim 1, wherein detecting a fraudulent event includes clustering a plurality of identified sequences.

6. The method of claim 5, further comprising identifying outlier clusters generated by the clustering process.

7. The method of claim 1, further comprising generating a severity score for the fraudulent event based at least in part on a frequency of sequence-based fraudulent events.

8. The method of claim 1, wherein reporting includes providing data regarding a fraudulent ring associated with more user accounts than user email addresses.

9. A non-transitory computer readable storage medium having embodied thereon a program, the program being executable by a processor to perform a method for performing continuous API-based fraud detection based on sequences, the method comprising:
continuously intercepting API traffic between a client and a server, the API traffic associated with multiple sequences of stages;
identifying a first sequence associated with a plurality of stages, the stages and sequence determined from the intercepted API traffic;
detecting whether the sequence of stages is associated with a fraudulent event; and
reporting an alert based on the detection of the fraudulent event.

10. The non-transitory computer readable storage medium of claim 9, wherein each of the stages is associated with an API request and response.

11. The non-transitory computer readable storage medium of claim 9, wherein detecting a fraudulent event includes applying API data to a prediction model, the API data generated based on the intercepted API traffic.

12. The non-transitory computer readable storage medium of claim 9, wherein detecting a fraudulent event includes identifying a fraudulent event associated with a selected stage within the first sequence.

13. The non-transitory computer readable storage medium of claim 9, wherein detecting a fraudulent event includes clustering a plurality of identified sequences.

14. The non-transitory computer readable storage medium of claim 13, the method further comprising identifying outlier clusters generated by the clustering process.

15. The non-transitory computer readable storage medium of claim 9, the method further comprising generating a severity score for the fraudulent event based at least in part on a frequency of sequence-based fraudulent events.

16. The non-transitory computer readable storage medium of claim 9, wherein reporting includes providing data regarding a fraudulent ring associated with more user accounts than user email addresses.

17. A system for performing continuous API-based fraud detection based on sequences, comprising:
a server including a memory and a processor; and
one or more modules stored in the memory and executed by the processor to continuously intercept API traffic between a client and a server, the API traffic associated with multiple sequences of stages, identify a first sequence associated with a plurality of stages, the stages and sequence determined from the intercepted API traffic, detect whether the sequence of stages is associated with a fraudulent event, and report an alert based on the detection of the fraudulent event.

18. The system of claim 17, wherein each of the stages is associated with an API request and response.

19. The system of claim 17, wherein detecting a fraudulent event includes applying API data to a prediction model, the API data generated based on the intercepted API traffic.

20. The system of claim 17, wherein detecting a fraudulent event includes identifying a fraudulent event associated with a selected stage within the first sequence.
